(19) United States
(12) Patent Application Publication
(10) Pub. No.: US 2025/0351213 A1
(43) Pub. Date: Nov. 13, 2025

(54) METHODS AND APPARATUSES FOR A RELAY PATH ESTABLISHMENT AND CHANGE IN MULTI-PATH CASE

(71) Applicant: Lenovo (Beijing) Limited, Beijing (CN)

(72) Inventors: Lianhai Wu, Beijing (CN); Ran Yue, Beijing (CN); Jing Han, Beijing (CN); Min Xu, Beijing (CN); Jie Hu, Beijing (CN)

(73) Assignee: Lenovo (Beijing) Limited, Beijing (CN)

(21) Appl. No.: 18/871,330

(22) PCT Filed: Jun. 24, 2022
(86) PCT No.: PCT/CN2022/101193

§ 371 Date: Dec. 3, 2024

(51) Int. Cl. H04W 76/18; H04W 76/27

(52) U.S. Cl. CPC H04W 76/18; H04W 76/27

(57) ABSTRACT

Embodiments of the subject application relate to methods and apparatuses for a relay path establishment and a relay change in a multi-path case. According to an embodiment of the subject application, a user equipment (UE) includes a processor and a transceiver coupled to the processor; and the processor is configured to: receive a radio resource control (RRC) reconfiguration message for path addition via the transceiver from a network, wherein the RRC reconfiguration message for path addition includes an identifier (ID) of a relay UE; start a timer for a path addition procedure upon reception of the RRC reconfiguration message; and receive a message associated with a link between the relay UE and the network.

### TECHNICAL FIELD

Embodiments of the present application generally relate to wireless communication technology, in particular to methods and apparatuses for a relay path establishment and a relay change in a multi-path case.

### BACKGROUND

Vehicle to everything (V2X) has been introduced into 5G wireless communication technology. In terms of a channel structure of V2X communication, the direct link between two user equipments (UEs) is called a sidelink. A sidelink is a long-term evolution (LTE) feature introduced in 3GPP Release 12, and enables a direct communication between proximal UEs, and data does not need to go through a base station (BS) or a core network.

In the 3rd Generation Partnership Project (3GPP), deployment of a relay node (RN) in a wireless communication system is promoted. One objective of deploying a RN is to enhance the coverage area of a BS by improving the throughput of a user equipment (UE) that is located in the coverage or far from the BS, which can result in relatively low signal quality. A RN may also be named as a relay UE in some cases. A 3GPP 5G sidelink system including a relay UE may be named as a sidelink relay system.

Currently, in a 3GPP 5G New Radio (NR) system or the like, details regarding a relay path establishment and a relay change in a multi-path case has not been specifically discussed yet. The multi-path case refers to a direct path and/or an indirect path via a relay UE. The multi-path may also be named as “multiple paths” or the like.

### SUMMARY

Some embodiments of the present application provide a user equipment (UE). The UE includes a processor and a transceiver coupled to the processor; and the processor is configured to: receive a first radio resource control (RRC) reconfiguration message for path addition via the transceiver from a network, wherein the first RRC reconfiguration message for path addition includes an identifier (ID) of a relay UE; start a timer for a path addition procedure upon reception of the first RRC reconfiguration message; and receive a first message associated with a link between the relay UE and the network.

In some embodiments, the first message is one of: a notification message received by the UE via the transceiver from the relay UE; and a PC5 unicast link release message.

In some embodiments, the notification message indicates at least one of: a Uu radio link failure (RLF) between the relay UE and the network; a cell reselection of the relay UE; a handover of the relay UE; an RRC connection failure of the relay UE; an RRC connection rejection message received by the relay UE; an expiry of a timer for RRC setup request at the relay UE; or an RRC resume failure of the relay UE.

In some embodiments, the processor of the UE is configured to stop the timer related to the path addition procedure upon reception of the first message.

In some embodiments, the processor of the UE is configured to: determine whether a cell change or a base station (BS) change of the relay UE occurs; release a PC5 link between the relay UE and the UE, in response to determining that the cell change or the BS change of the relay UE occurs; or continue to establish and keep the PC5 link, in response to determining that the cell change or the BS change of the relay UE does not occur.

In some embodiments, the processor of the UE is configured to transmit an indication for indicating that the PC5 link has been released or not via the transceiver to the network. In an embodiment, the indication is transmitted upon reception of the first message. In a further embodiment, the indication is transmitted upon stopping the timer for the path addition procedure.

In some embodiments, wherein the processor of the UE is configured to: initiate a failure information procedure upon reception of the first message; and transmit a failure message including a failure cause via the transceiver to the network, wherein the failure cause is one of: reception of a notification message due to a Uu RLF between the relay UE and the network; reception of a notification message due to a cell reselection of the relay UE; reception of a notification message due to a handover of the relay UE; reception of a notification message due to an RRC connection failure of the relay UE; reception of a notification message due to an RRC connection rejection message received by the relay UE; reception of a notification message due to an expiry of a timer for RRC setup request at the relay UE; reception of a notification message due to an RRC resume failure of the relay UE; or reception of a PC5 unicast link release message indicated by an upper layer of the UE.

In some embodiments, the processor of the UE is configured to: store configuration information including the ID of the relay UE in response to that the UE keeps a PC5 link between the relay UE and the UE after receiving the first message; receive a second RRC reconfiguration message including the ID of the relay UE for the path addition procedure; and re-add the path between the relay UE and the network using the stored configuration information.

In some embodiments, the processor of the UE is configured to transmit information regarding an intra-cell path addition or an intra-BS path addition via the transceiver to the relay UE.

In some embodiments, the processor of the UE is configured to receive a PC5 unicast link release message or a rejection message due to occurrence of a cell change or a BS change of the relay UE via the transceiver from the relay UE.

Some embodiments of the present application also provide a UE. The UE includes a processor and a transceiver coupled to the processor; and the processor is configured to: access a serving cell of a network via multiple paths, wherein the multiple paths include at least one of a direct path and a first indirect path via a source relay UE; receive, via the transceiver from the serving cell, one of: a radio resource control (RRC) reconfiguration message for a path switch procedure from the first indirect path to a second indirect path via a target relay UE, a release message without a suspend configuration, and a release message including the suspend configuration; and release the first indirect path upon reception of the release message without the suspend configuration.

In some embodiments, upon reception of the RRC reconfiguration message, the processor of the UE is configured to: initiate the path switch procedure to the second indirect path via the target relay UE; and start a timer for the path switch procedure.

In some embodiments, the processor of the UE is configured to: transmit an RRC reconfiguration complete message; and stop the timer for the path switching procedure upon transmitting the RRC reconfiguration complete message.

In some embodiments, the processor of the UE is configured to transmit failure information to the network in response to an expiry of the timer for the path switching procedure.

In some embodiments, the processor of the UE is configured to fall back to access the serving cell via the first indirect path, in response to an expiry of the timer for the path switch procedure and the first indirect path being available.

In some embodiments, the processor of the UE is configured to: maintain the first indirect path in response to receiving the RRC reconfiguration message for the path switch procedure; receive a first message or detect a radio link failure (RLF) on a PC5 link between the UE and the source relay UE in response to the timer for the path switch procedure being running; and release the first indirect path.

In some embodiments, the first message is one of: a notification message received by the UE via the transceiver from the source relay UE; and a PC5 unicast link release message.

In some embodiments, the notification message indicates at least one of: a Uu radio link failure (RLF) between the source relay UE and the network; a cell reselection of the source relay UE; a handover of the source relay UE; an RRC connection failure of the source relay UE; an RRC connection rejection message received by the source relay UE; an expiry of a timer for RRC setup request at the source relay UE; or an RRC resume failure of the source relay UE.

In some embodiments, upon reception of the release message including the suspend configuration, the processor of the UE is configured to: release the first indirect path; and transit to an RRC inactive state.

In some embodiments, upon reception of the release message including the suspend configuration, the processor of the UE is configured to: store configuration information related to the first indirect path; and release the first indirect path in response to initiation of resuming a connection between the UE and the source relay UE.

Some embodiments of the present application also provide a relay UE. The relay UE includes a processor and a transceiver coupled to the processor; and the processor is configured to transmit a first message associated with a link between the relay UE and a network via the transceiver to a remote UE, wherein the first message is one of: a notification message; a PC5 unicast link release message; and a rejection message due to occurrence of a cell change or a base station (BS) change.

In some embodiments, the relay UE is a target relay UE during a path addition procedure.

In some embodiments, the notification message indicates at least one of: a Uu radio link failure (RLF) between the target relay UE and the network; a cell reselection of the target relay UE; a handover of the target relay UE; an RRC connection failure of the target relay UE; an RRC connection rejection message received by the target relay UE; an expiry of a timer for RRC setup request at the target relay UE; or an RRC resume failure of the target relay UE.

In some embodiments, the processor of the target relay UE is configured to receive information regarding an intra-cell path addition or an intra-BS path addition via the transceiver from the remote UE.

In some embodiments, during the path addition procedure, the processor of the target relay UE is configured to: not change from a first cell to a second cell or not change from a first BS to a second BS during a cell selection or reselection operation, in response to the target relay UE in an RRC idle state or an inactive state; or not enter into an RRC connected state, in response to that the target relay UE changes to the second cell or the second BS.

In some embodiments, the PC5 unicast link release message or the rejection message is transmitted by the target relay UE in response to that the target relay UE changes to the second cell or the second BS.

In some embodiments, the relay UE is a source relay UE during a path switch procedure from a first indirect path to a second indirect path, wherein the first indirect path is between the remote UE and the network via the source relay UE, and wherein the second indirect path is between the remote UE and the network via a second target relay UE.

In some embodiments, the notification message indicates at least one of: a Uu radio link failure (RLF) between the source relay UE and the network; a cell reselection of the source relay UE; a handover of the source relay UE; an RRC connection failure of the source relay UE; an RRC connection rejection message received by the source relay UE; an expiry of a timer for RRC setup request at the source relay UE; or an RRC resume failure of the source relay UE.

Some embodiments of the present application provide a method, which may be performed by a UE. The method includes: receiving a first radio resource control (RRC) reconfiguration message for path addition from a network, wherein the first RRC reconfiguration message for path addition includes an identifier (ID) of a relay UE; starting a timer for a path addition procedure upon reception of the first RRC reconfiguration message; and receiving a first message associated with a link between the relay UE and the network.

Some embodiments of the present application provide a method, which may be performed by a relay UE. The method includes: accessing a serving cell of a network via multiple paths, wherein the multiple paths include at least one of a direct path and a first indirect path via a source relay UE; receiving, from the serving cell, one of: a radio resource control (RRC) reconfiguration message for a path switch procedure from the first indirect path to a second indirect path via a target relay UE, a release message without a suspend configuration, and a release message including the suspend configuration; and releasing the first indirect path upon reception of the release message without the suspend configuration.

Some embodiments of the present application provide a method, which may be performed by a UE. The method includes: transmitting a first message associated with a link between the relay UE and a network to a remote UE, wherein the first message is one of: a notification message; a PC5 unicast link release message; and a rejection message due to occurrence of a cell change or a base station (BS) change.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned method performed by a remote UE or a relay UE.

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2 illustrates an exemplary flowchart of a sidelink RRC reconfiguration procedure in accordance with some embodiments of the present application.

FIG. 3 illustrates an exemplary flowchart regarding a path addition procedure in accordance with some embodiments of the present application.

FIG. 4 illustrates an exemplary flowchart regarding a path switch procedure in accordance with some embodiments of the present application.

FIG. 5 illustrates an exemplary flowchart regarding a path addition or switch procedure in accordance with some embodiments of the present application.

FIG. 6 illustrates an exemplary flowchart for a path addition procedure in accordance with some embodiments of the present application.

FIG. 7 illustrates an exemplary flowchart for a path switch procedure in a multi-path case in accordance with some embodiments of the present application.

FIG. 8 illustrates an exemplary block diagram of an apparatus for a multi-path case in accordance with some embodiments of the subject application.

FIG. 9 illustrates a further exemplary block diagram of an apparatus for a multi-path case in accordance with some embodiments of the subject application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd Generation Partnership Project (3GPP) LTE and LTE advanced, 3GPP 5G NR, 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

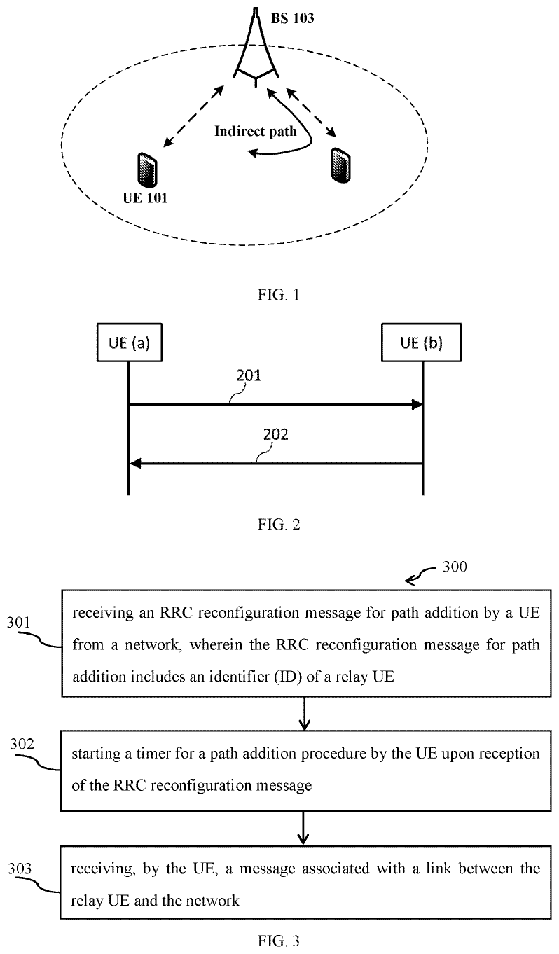

FIG. 1 illustrates a schematic diagram of a wireless communication system in accordance with some embodiments of the present application. As illustrated and shown in FIG. 1, a wireless communication system 100 includes at least two UEs (i.e., UE 101 and relay UE 102) and at least one BS (e.g., BS 103) for illustrative purpose. Although a specific number of UE(s) and BS(s) are depicted in FIG. 1, it is contemplated that any number of UE(s) and BS(s) may be included in the wireless communication system 100. As shown in FIG. 1. UE 101 may communicate with BS 103 via a direct path between UE 101 and BS 103 or via an indirect path between the UE 101 and BS 103 through relay UE 102.

UE(s) in the wireless communication system 100 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), internet of things (IoT) devices, or the like. According to some embodiments of the present application, UE(s) may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present application, UE(s) includes wearable devices, such as smart watches, fitness bands, optical head-mounted displays, or the like. Moreover, UE(s) may be referred to as a subscriber unit, a mobile, a mobile station, a user, a terminal, a mobile terminal, a wireless terminal, a fixed terminal, a subscriber station, a user terminal, or a device, or described using other terminology used in the art. UE(s) may communicate directly with BS(s) via UL communication signals.

In some embodiments of the present application, each of UE(s) may be deployed an IoT application, an enhanced mobile broadband (eMBB) application and/or an ultra-reliable and low latency communication (URLLC) application. It is contemplated that the specific type of application(s) deployed in UE(s) may be varied and not limited.

BS(s) in the wireless communication system 100 may be distributed over a geographic region. In certain embodiments of the present application, each of BS(s) may also be referred to as an access point, an access terminal, a base, a base unit, a macro cell, a Node-B, an evolved Node B (eNB), a gNB, a NG-RAN (Next Generation-Radio Access Network) node, a Home Node-B, a relay node, or a device, or described using other terminology used in the art. BS(s) is generally a part of a radio access network that may include one or more controllers communicably coupled to one or more corresponding BS(s). Each of BS(s) may include one or more cells. Each UE(s) may perform a cell section procedure between different cell(s) of different BS(s).

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G new radio (NR) of the 3GPP protocol, wherein BS(s) transmit data using an OFDM modulation scheme on the DL and UE(s) 101 transmit data on the UL using a single-carrier frequency division multiple access (SC-FDMA) or OFDM scheme. More generally, however, the wireless communication system 100 may implement some other open or proprietary communication protocols, for example, WiMAX, among other protocols.

In some embodiments of the present application, BS(s) in the wireless communication system 100 may communicate using other communication protocols, such as the IEEE 802.11 family of wireless communication protocols. Further, in some embodiments of the present application, BS(s) may communicate over licensed spectrums, whereas in other embodiments, BS(s) may communicate over unlicensed spectrums. The present application is not intended to be limited to the implementation of any particular wireless communication system architecture or protocol. In yet some embodiments of present application, BS(s) may communicate with UE(s) using the 3GPP 5G protocols.

FIG. 2 illustrates an exemplary flowchart of a sidelink RRC reconfiguration procedure in accordance with some embodiments of the present application. As shown in FIG. 2, in step 201, UE (a) (e.g., UE 101 as illustrated and shown in FIG. 1) initiates a sidelink RRC reconfiguration procedure to UE (b) (e.g., relay UE 102 as illustrated and shown in FIG. 1) by transmitting an RRCReconfigurationSidelink message to UE (b).

If the sidelink RRC reconfiguration procedure is successfully completed, in step 202, UE (b) may transmit “an RRC reconfiguration complete sidelink message” to UE (a), e.g., an RRCReconfigurationCompleteSidelink message as specified in 3GPP standard documents. Alternatively, if the sidelink RRC reconfiguration procedure is not successfully completed, in step 202, UE (b) may transmit “an RRC reconfiguration failure sidelink message” to UE (a), e.g., an RRCReconfigurationFailureSidelink message as specified in 3GPP standard documents.

The purpose of a sidelink RRC reconfiguration procedure is to modify a PC5 RRC connection, e.g., to establish, modify, or release sidelink data radio bearers (DRBs), to configure NR sidelink measurement and reporting, and to configure sidelink channel state information (CSI) reference signal resources.

A UE (e.g., UE (a) as illustrated and shown in FIG. 2) may initiate the sidelink RRC reconfiguration procedure and perform operations on the corresponding PC5 RRC connection in following cases:
a release of sidelink DRBs associated with a peer UE (e.g., UE (b) as illustrated and shown in FIG. 2);
an establishment of sidelink DRBs associated with the peer UE;
a modification for the parameters included in Sidelink radio bearer (SLRB)-Config of sidelink DRBs associated with the peer UE;
configuration information of the peer UE to perform NR sidelink measurement and report; and
configuration information of the sidelink CSI reference signal resources.

A UE capable of NR sidelink communication may initiate a procedure of sidelink UE information for NR, to report to a network or a BS that a sidelink radio link failure (RLF) (e.g., timer T400 expiry) or a sidelink RRC reconfiguration failure has been declared.

Embodiments of the present application aim to solve issues associated with multiple paths in the case of L2 UE-to-Network (U2N) relay. Some embodiments of the present application provide a mechanism of handling an ongoing path addition procedure when a remote UE receives a notification message or a PC5 unicast link release message (e.g., a PC5-S message) during a path addition procedure. For example, the reception of a notification message can be a trigger condition to transmit a failure information report and/or stop the timer for path addition.

Some embodiments of the present application study a mechanism of releasing or keeping a PC5 link in the case that a remote UE receives a PC5 unicast link release message (e.g., PC5-S message) or a notification message during a path addition procedure. For example, some embodiments introduce optimized solutions if the remote UE keeps a PC5 link. Some embodiments of the present application provide solutions of re-adding an indirect path via a relay UE. Some other embodiments of the present application provide solutions of avoiding a cell change or a BS change of a relay UE during a relay path addition.

Some embodiments of the present application study a case when a failure happens during a relay change procedure. For example, in some embodiments, if a source relay link is not released while performing a relay UE change procedure, a remote UE can fall back to the source relay UE link if the source relay path is still available. In some embodiments, if the remote UE receives a PC5 unicast link release message (e.g., PC5-S message) or a notification message due to a Uu RLF, a handover of a source relay UE, or the remote UE detects an RLF on the source PC5 link, the remote UE may release the source indirect path.

More details will be illustrated in the following text in combination with the appended drawings. Persons skilled in the art should well know that the wording “a/the first,” “a/the second” and “a/the third” etc. are only used for clear description, and should not be deemed as any substantial limitation, e.g., sequence limitation.

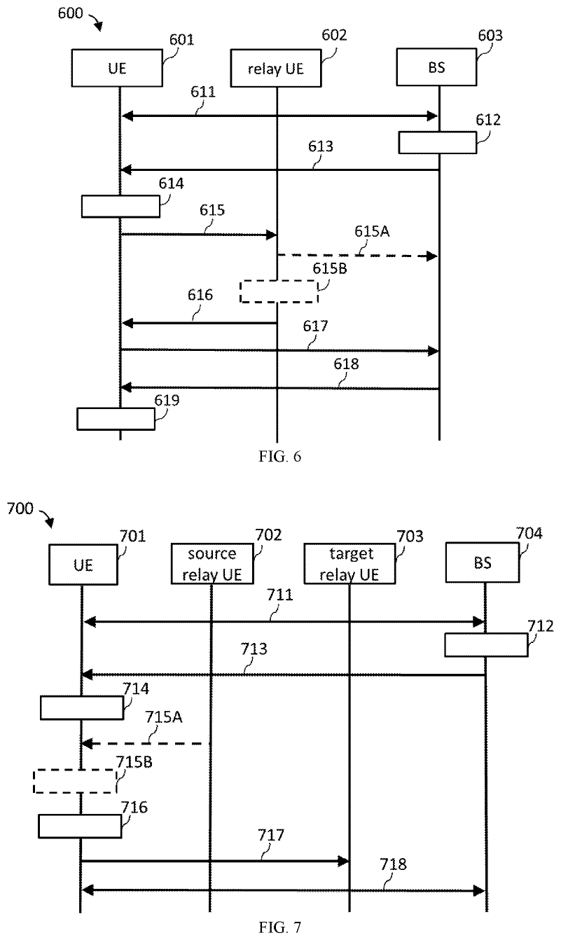

FIG. 3 illustrates an exemplary flowchart regarding a path addition procedure in accordance with some embodiments of the present application. The exemplary method 300 in FIG. 3 may be performed by a UE (e.g., UE 101, UE (a) or UE 601 as shown in any of FIGS. 1, 2, and 6). Specific examples are described in embodiments of FIG. 6 and Embodiment 1 as follows. Although described with respect to a UE, it should be understood that other devices may be configured to perform a method similar to that of FIG. 3.

In the exemplary method 300 in FIG. 3, in operation 301, a UE receives an RRC reconfiguration message for path addition from a network (e.g., BS 103 as shown in FIG. 1 or BS 603 as shown in FIG. 6). The RRC reconfiguration message for path addition includes an ID of a relay UE (e.g., relay UE 102 as shown in FIG. 1 or relay UE 602 as shown in FIG. 6).

In operation 302, the UE starts a timer for a path addition procedure upon reception of the RRC reconfiguration message.

In operation 303, the UE receives a message associated with a link between the relay UE and the network. This message is denoted as “the first message” for simplicity. In some embodiments, the UE may stop the timer related to the path addition procedure upon reception of the first message.

In some embodiments, the first message may be one of: a notification message received by the UE from the relay UE; and a PC5 unicast link release message (e.g., a PC5-S message). In an embodiment, the notification message indicates at least one of:
(1) a Uu RLF between the relay UE and the network;
(2) a cell reselection of the relay UE;
(3) a handover of the relay UE;
(4) an RRC connection failure of the relay UE;
(5) an RRC connection rejection message received by the relay UE;
(6) an expiry of a timer for RRC setup request at the relay UE; or
(7) an RRC resume failure of the relay UE.

In some embodiments, the UE may determine whether a cell change or a BS change of the relay UE occurs. The UE may release a PC5 link between the relay UE and the UE, in response to determining that the cell change or the BS change of the relay UE occurs. Or, the UE may continue to establish and keep the PC5 link, in response to determining that the cell change or the BS change of the relay UE does not occur.

In some embodiments, the UE may transmit an indication for indicating that the PC5 link has been released or not to the network. In an embodiment, the indication is transmitted upon reception of the first message. In a further embodiment, the indication is transmitted upon stopping the timer for the path addition procedure.

In some embodiments, the UE may initiate a failure information procedure upon reception of the first message, and transmit a failure message including a failure cause to the network. For instance, the failure cause may be one of:
(1) reception of a notification message due to a Uu RLF between the relay UE and the network; reception of a notification message due to a cell reselection of the relay UE;
(2) reception of a notification message due to a handover of the relay UE;
(3) reception of a notification message due to an RRC connection failure of the relay UE;
(4) reception of a notification message due to an RRC connection rejection message received by the relay UE;
(5) reception of a notification message due to an expiry of a timer for RRC setup request at the relay UE;
(6) reception of a notification message due to an RRC resume failure of the relay UE; or
(7) reception of a PC5 unicast link release message indicated by an upper layer of the UE.

In some embodiments, the UE may store configuration information including the ID of the relay UE in response to that the UE keeps a PC5 link between the relay UE and the UE after receiving the first message. The UE may receive another RRC reconfiguration message including the ID of the relay UE for the path addition procedure. Then, the UE may re-add the path between the relay UE and the network using the stored configuration information.

In some embodiments, the UE may transmit information regarding an intra-cell path addition or an intra-BS path addition to the relay UE.

In some embodiments, the UE may receive, from the relay UE, a PC5 unicast link release message or a rejection message due to occurrence of a cell change or a BS change of the relay UE. For example, the rejection message is a rejection message in response to direct communication request (DCR), as described in Embodiment 1 as below.

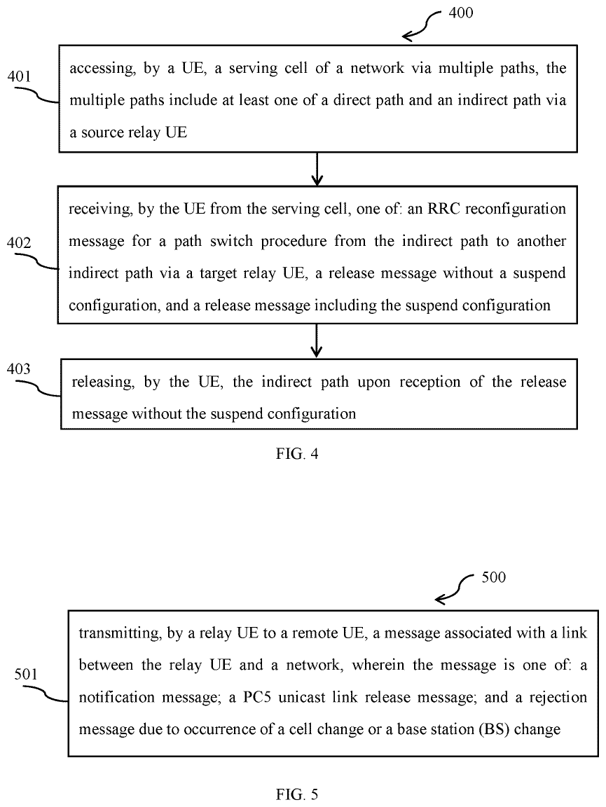

FIG. 4 illustrates an exemplary flowchart regarding a path switch procedure in accordance with some embodiments of the present application. The exemplary method 400 in FIG. 4 may be performed by a UE (e.g., UE 101, UE (a) or UE 701 as shown in any of FIGS. 1, 2, and 7). Specific examples are described in embodiments of FIG. 7 and Embodiments 2 and 3 as follows. Although described with respect to a UE, it should be understood that other devices may be configured to perform a method similar to that of FIG. 4.

In the exemplary method 400 in FIG. 4, in operation 401, a UE may access a serving cell of a network (e.g., BS 103 as shown in FIG. 1 or BS 704 as shown in FIG. 7) via multiple paths. The multiple paths include a direct path and/or an indirect path via a source relay UE (e.g., relay UE 102 as shown in FIG. 1 or target relay UE 703 as shown in FIG. 7). The indirect path is denoted as “the first indirect path” for simplicity.

In operation 402, the UE may receive one of the following from the serving cell:
(1) an RRC reconfiguration message for a path switch procedure from the first indirect path to another indirect path (denoted as “the second indirect path” for simplicity) via a target relay UE (e.g., target relay UE 703 as shown in FIG. 7),
(2) a release message without a suspend configuration, and
(3) a release message including the suspend configuration.

In operation 403, the UE may release the first indirect path upon reception of the release message without the suspend configuration.

In some embodiments, upon reception of the RRC reconfiguration message, the UE may initiate the path switch procedure to the second indirect path via the target relay UE, and start a timer for the path switch procedure. In an embodiment, the UE may transmit an RRC reconfiguration complete message, and stop the timer for the path switching procedure upon transmitting the RRC reconfiguration complete message.

In some embodiments, the UE may transmit failure information to the network in response to an expiry of the timer for the path switching procedure.

In some embodiments, the UE may fall back to access the serving cell via the first indirect path, in response to an expiry of the timer for the path switch procedure and the first indirect path being available.

In some embodiments, the UE may maintain the first indirect path in response to receiving the RRC reconfiguration message for the path switch procedure, receive a message or detect an RLF on a PC5 link between the UE and the source relay UE in response to the timer for the path switch procedure being running, and release the first indirect path. In an embodiment, the first message is one of: a notification message received by the UE from the source relay UE; and a PC5 unicast link release message (e.g., a PC5-S message). For instance, the notification message indicates at least one of:
(1) a Uu RLF between the source relay UE and the network;
(2) a cell reselection of the source relay UE;
(3) a handover of the source relay UE;
(4) an RRC connection failure of the source relay UE;
(5) an RRC connection rejection message received by the source relay UE;
(6) an expiry of a timer for RRC setup request at the source relay UE; or
(7) an RRC resume failure of the source relay UE.

In some embodiments, upon reception of the release message including the suspend configuration, the UE may release the first indirect path and transit to an RRC inactive state.

In some embodiments, upon reception of the release message including the suspend configuration, the UE may store configuration information related to the first indirect path, and release the first indirect path in response to initiation of resuming a connection between the UE and the source relay UE.

FIG. 5 illustrates an exemplary flowchart regarding a path addition or switch procedure in accordance with some embodiments of the present application. The exemplary method 500 in FIG. 5 may be performed by a relay UE (e.g., UE 101, UE (a), UE 601, or UE 701 as shown in any of FIGS. 1, 2, 6, and 7). Specific examples are described in embodiments of FIGS. 6 and 7 and Embodiments 1-3 as follows. Although described with respect to a relay UE, it should be understood that other devices may be configured to perform a method similar to that of FIG. 5.

In the exemplary method 500 in FIG. 5, in operation 501, a relay UE transmits a message associated with a link between the relay UE and a network to a remote UE (e.g., UE 101 as shown in FIG. 1, UE 601 as shown in FIG. 6, or UE 701 as shown in FIG. 7). The message may be one of: a notification message; a PC5 unicast link release message; and a rejection message due to occurrence of a cell change or a base station (BS) change.

In some embodiments, the relay UE is a target relay UE during a path addition procedure. In an embodiment, the notification message transmitted in operation 501 indicates at least one of:
(1) a Uu RLF between the target relay UE and the network;
(2) a cell reselection of the target relay UE;
(3) a handover of the target relay UE;
(4) an RRC connection failure of the target relay UE;
(5) an RRC connection rejection message received by the target relay UE;
(6) an expiry of a timer for RRC setup request at the target relay UE; or
(7) an RRC resume failure of the target relay UE.

In some embodiments, the target relay UE may receive information regarding an intra-cell path addition or an intra-BS path addition from the remote UE.

In some embodiments, during the path addition procedure, the target relay UE may not change from a cell to another cell or not change from a BS to another BS during a cell selection or reselection operation, in response to the target relay UE in an RRC idle state or an inactive state. In some other embodiments, during the path addition procedure, the target relay UE may not enter into an RRC connected state, in response to that the target relay UE changes to the another cell or the another BS. In an embodiment, the PC5 unicast link release message (e.g., a PC5-S message) or the rejection message is transmitted by the target relay UE in response to that the target relay UE changes to the second cell or the second BS. Specific examples are described in embodiments of FIG. 6 and Embodiment 1 as follows. For example, the rejection message is a rejection message in response to direct communication request (DCR), as described in Embodiment 1 as below.

In some embodiments, the relay UE is a source relay UE during a path switch procedure from a first indirect path to a second indirect path, wherein the first indirect path is between the remote UE and the network via the source relay UE, and wherein the second indirect path is between the remote UE and the network via a second target relay UE.

In some embodiments, the notification message indicates at least one of: a Uu RLF between the source relay UE and the network; a cell reselection of the source relay UE; a handover of the source relay UE; an RRC connection failure of the source relay UE; an RRC connection rejection message received by the source relay UE; an expiry of a timer for RRC setup request at the source relay UE; or an RRC resume failure of the source relay UE. Specific examples are described in embodiments of FIG. 7 and Embodiments 2 and 3 as follows.

It should be appreciated by persons skilled in the art that the sequence of the operations in the exemplary flowcharts 300, 400, and 500 may be changed, and some of the operations in the exemplary flowcharts 300, 400, and 500 may be eliminated or modified, without departing from the spirit and scope of the disclosure. Details described in all other embodiments of the subject application, e.g., in the embodiments of FIGS. 3-5 are applicable for this exemplary flowchart. Moreover, details described in this exemplary flowchart are applicable for all the embodiments of FIGS. 1, 2, and 6-9.

FIG. 6 illustrates an exemplary flowchart for a path addition procedure in accordance with some embodiments of the present application. In the embodiments of FIG. 6, UE 601 (e.g., UE 101 or UE (a) as shown and illustrated in FIG. 1 or FIG. 2) may also be named as a remote UE. Relay UE 602 may be relay UE 102 as shown and illustrated in FIG. 1. BS 603 may be BS 103 as shown and illustrated in FIG. 1.

As shown in FIG. 6, in operation 611, UE 601 accesses the serving BS (i.e., BS 603) via a Uu link, e.g., a direct path. UE 601 may report measurement result(s) based on the configuration from BS 603.

In operation 612, the serving BS 603 decides to add another indirect path based on the measurement result(s).

In operation 613, BS 603 transmits an RRC reconfiguration message to the remote UE.

In operation 614, once UE 601 receives the RRC reconfiguration message for path addition, UE 601 starts a timer for path addition. The timer for path addition could be timer T420 (see 3GPP standard document TS38.331). In some embodiments, an ID of a relay UE (i.e., L2 U2N relay UE, e.g., relay UE 602) is included in the RRC reconfiguration message for path addition.

In operation 615, after UE 601 receives the RRC reconfiguration message for path addition, UE 601 transmits the request signalling to relay UE 602 for establishing a PC5 connection. If relay UE 602 is in an RRC connected state, relay UE 602 may detect an RLF and transmit a PC5 unicast link release (e.g., a PC5-S message) or a notification message including an indication type, which is set as Uu RLF, to UE 601 (i.e., the remote UE).

In some embodiments, in operation 615A (which is optional as marked as a dotted line), if relay UE 602 is in an RRC idle or inactive state, relay UE 602 will request to establish the RRC connection. Before relay UE 602 transmits the request to the network (e.g., BS 603), relay UE 602 may perform a cell reselection in operation 615B (which is optional as marked as a dotted line). Relay UE 602 may transmit a PC5 unicast link release (e.g., a PC5-S message) or a notification message due to the cell reselection, an RRC connection failure of relay UE 602, and/or an RRC resume failure. For instance, the RRC connection failure may include an RRC connection rejection and/or an expiry of a timer for RRC setup request (e.g., T300) at relay UE 602.

In operation 616, UE 601 may receive the PC5 unicast link release (PC5-S message) or the notification message due to a Uu RLF, an RRC reconfiguration message including reconfiguration with synchronization, a cell reselection, a RRC connection failure (which may include an RRC connection rejection and/or an expiry of a timer for RRC setup request), and/or an RRC resume failure.

In some embodiments, UE 601 may stop the timer for path addition upon a PC5 unicast link release (e.g., PC5-S layer message) indicated by an upper layer (PC5-S layer) of UE 601 or upon reception of the notification message due to the Uu RLF, the RRC reconfiguration message including reconfiguration with synchronization, the cell reselection, the RRC connection failure, and/or the RRC resume failure.

In some embodiments, UE 601 may trigger to report failure information including the failure cause to BS 603 upon the PC5 unicast link release (e.g., PC5-S message) indicated by the upper layer of UE 601 or upon the reception of notification message due to the Uu RLF, the RRC reconfiguration message including reconfiguration with synchronization, the cell reselection, the RRC connection failure, and/or the RRC resume failure.

For instance, the failure cause could be: reception of the PC5 unicast link release (e.g., PC5-S message); or reception of the notification message due to the Uu RLF, the RRC reconfiguration message including reconfiguration with synchronization, the cell reselection, the RRC connection failure, and/or the RRC resume failure.

In operation 617, UE 601 may transmit a report of failure information to BS 603 after receiving the PC5 unicast link release (e.g., PC5-S message) or the notification message or detecting an RLF on the PC5 link between UE 601 and relay UE 602.

In some embodiments, if UE 601 identifies a BS change (or a cell change) of relay UE 602, UE 601 can directly release the PC5 link between UE 601 and relay UE 602. Otherwise, UE 601 can continue to establish and keep the PC5 connection.

In some embodiments, the indication that the PC5 connection is released or not may be included in the report of failure information.

In some embodiments, the indication that “cell or BS change” can be transmitted to BS 603 after the notification message has been transmitted if UE 601 has not received a response from BS 603.

In operation 618, UE 601 may receive the response from BS 603. In some embodiments, if PC5 is not released and relay UE 602 connects to the same serving cell or the same BS (i.e., BS 603), the serving cell can indicate UE 601 to re-connect the indirect path. In operation 619, UE 601 will establish the indirect path based on the response from BS 603 in operation 618.

In some embodiments, UE 601 stores the original RRC reconfiguration related to relay UE 602. Then, UE 601 receives another RRC reconfiguration message including only one indication from BS 603 in operation 618. Once UE 601 receives the only one indication, UE 601 may or may not start the timer for path addition, and UE 601 may directly transmit the another RRC reconfiguration message to relay UE 602. The path between relay UE 602 and BS 603 may be re-added using the stored original RRC configuration information related to relay UE 602 in operation 619.

In some other embodiments, BS 603 may transmit an indication to release the PC5 link to UE 601 in operation 618. If the PC5 link is released, BS 603 will transmit an RRC reconfiguration message including configuration with sync IE to UE 601. UE 601 may perform a normal path addition procedure in operation 619.

FIG. 7 illustrates an exemplary flowchart for a path switch procedure in a multi-path case in accordance with some embodiments of the present application. In the embodiments of FIG. 7, UE 701 (e.g., UE 101 or UE (a) as shown and illustrated in FIG. 1 or FIG. 2) may also be named as a remote UE. BS 704 may be BS 103 as shown and illustrated in FIG. 1. Source relay UE 702 may be relay UE 102 as shown and illustrated in FIG. 1. Target relay UE 702 may be another relay UE not shown in FIG. 1.

As shown in FIG. 7, in operation 711, UE 701 accesses the serving BS (i.e., BS 704) via multiple paths, e.g., one direct path and one indirect path. UE 701 stays at an RRC connected state. The indirect path is associated with a relay UE (e.g., source relay UE 702).

In operation 712, BS 704 decides to switch from source relay UE 702 to another relay UE (e.g., target relay UE 703) based on measurement report(s) from UE 701.

In operation 713, BS 704 may transmit an RRC reconfiguration message associated with the indirect path switching to UE 701. For instance, the RRC reconfiguration message may include configuration with synchronization.

In operation 714, once UE 701 receives reconfiguration message for indirect path switching, UE 701 starts the timer for path switching. In some embodiments, after UE 701 receives an RRC reconfiguration message for indirect path switching, UE 701 may release a source PC5 RRC connection between UE 701 and source relay UE 702, i.e., a source PC5 link. In some other embodiments, UE 701 may keep the source PC5 RRC connection. In the embodiments that UE 701 decides to keep the source PC5 RRC connection, following operations 715A-718 may be performed.

In operation 715A (which is optional as marked as a dotted line), UE 701 may receive a PC5 unicast link release message (e.g., PC5-S message) or a notification message from source relay UE 702. Or, in operation 715B (which is optional as marked as a dotted line), UE 701 may detect an RLF on the PC5 link between UE 701 and source relay UE 702 while the timer for path switching. After operation 715A or 715B, UE 701 may release the source indirect path associated with source relay UE 702 in operation 716.

In operation 717, UE 701 may transmit an RRC reconfiguration complete message to target relay UE 703, once the PC5 link associated with target relay UE 703 is established. Target relay UE 703 may transfer the RRC reconfiguration complete message to BS 704. In some embodiments, UE 701 may stop the timer for path switching upon UE 701 transmitting the RRC reconfiguration complete message to BS 704 via target relay UE 703.

In operation 718, UE 701 may transmit data to BS 704 or receive data from BS 704 via target relay UE 703.

Details described in all other embodiments of the present application (for example, details regarding how to handle establishment and failure in a multi-path case) are applicable for the embodiments of FIG. 6 or FIG. 7. Moreover, details described in the embodiments of FIG. 6 or FIG. 7 are applicable for all embodiments of FIGS. 1-5, 8, and 9. It should be appreciated by persons skilled in the art that the sequence of the operations in exemplary procedure in the embodiments of FIG. 6 or FIG. 7 may be changed and some of the operations in exemplary procedure in the embodiments of FIG. 6 or FIG. 7 may be eliminated or modified, without departing from the spirit and scope of the disclosure.

The following texts describe specific Embodiments 1-3 of the methods as shown and illustrated in FIGS. 3-7. According to Embodiments 1-3, a UE (e.g., UE 101 or UE (a) as shown and illustrated in FIG. 1 or FIG. 2), a relay UE (e.g., relay UE 102 as shown and illustrated in FIG. 1), and a network node (e.g., BS 103 as shown and illustrated in FIG. 1) perform following operations.

Embodiment 1 aims to solve an issue of how to avoid a cell or BS change of a relay UE during an indirect path addition procedure. In Embodiment 1, following operations (1)-(7) are performed.

In operation (1), a UE accesses a serving BS via a Uu link. The UE stays at an RRC connected state. The UE may report measurement result(s) based on the configuration from the serving BS. The UE may also be named as the remote UE.

In operation (2), the serving BS decides to add an indirect path based on the measurement result(s). The serving BS transmits an RRC reconfiguration message to the remote UE.

In operation (3), once the remote UE receives the RRC reconfiguration message for path addition, the remote UE starts the timer for path addition. For example, the timer for path addition could be timer T420.

In operation (4), after the remote UE receives the RRC reconfiguration message for path addition, the remote UE transmits the request signalling to the relay UE for establishing a PC5 connection between the remote UE and the relay UE.

In some embodiments, if the relay UE is in an RRC connected state, the relay UE may detect an RLF and transmit a notification message (e.g., which including an indication type that is set as an Uu RLF) to the remote UE.

In some other embodiments, if the relay UE is in an RRC idle or inactive state, the relay UE may request to establish the RRC connection. In some other embodiments, before the relay UE transmits the request to the network (i.e., the serving BS), the relay UE may perform a cell reselection. The relay UE may transmit a notification message due to a cell reselection, L2 U2N Relay UE's RRC connection failure including an RRC connection rejection and/or T300 expiry, and/or an RRC resume failure.

In some embodiments, the information about Intra-cell or Intra-BS indirect path addition may be indicated to the relay UE, e.g., in a request of PC5 establishment message. In an embodiment, if the relay UE is in an RRC idle or inactive state, the relay UE will not change to another cell or another BS during a cell selection or a cell reselection. In another embodiment, if relay UE has to change to another cell or another BS, the relay UE will not enter the RRC connected state and will inform the remote UE. Then, the relay UE may transmit the PC5-S release message or may reject in response to direct communication request (DCR).

In operation (5), the remote UE may receive a response from the relay UE. That is, the PC5 connection is established.

In operation (6), the remote UE may transmit an RRC reconfiguration complete message to the serving BS via the relay UE. Then, the remote UE stops the timer for path addition.

In operation (7), the remote UE may establish the indirect path based on a response from the serving BS.

Embodiment 2 aims to solve an issue regarding a case in which a failure happens during a relay change. In Embodiment 2, following operations (A)-(D) are performed.

In operation (A), a UE accesses a serving BS via multi-paths (e.g., a direct path and/or an indirect path). The UE stays at an RRC connected state. The UE may also be named as the remote UE.

In operation (B), the serving BS decides to release the connected remote UE to an RRC idle state.

In operation (C), the remote UE receives a release message from the serving BS. In some embodiments, if the remote UE configured with multi-paths receives the release message, the remote UE needs to release configuration associated with the indirect path (i.e., the relay link path) upon transition to the RRC idle state.

In operation (D), the remote UE enters to an RRC idle state.

Embodiment 3 also aims to solve an issue regarding a case in which a failure happens during a relay change. In Embodiment 3, following operations (a)-(e) are performed.

In operation (a), a UE accesses the serving BS via multi-paths (e.g., a direct path and/or an indirect path). The UE stays at an RRC connected state. The UE may also be named as the remote UE.

In operation (b), the serving BS decides to release the connected remote UE to an RRC inactive state.

In operation (c), the remote UE receives a release message including suspend configuration from the serving BS. In some embodiments, if the UE configured with multi-paths receives the release message including suspend configuration, the remote UE needs to release the configuration associated with the indirect path (i.e., the relay link path) upon transition to the RRC inactive state. In some other embodiments, if the UE configured with multi-paths receives the release message including suspend configuration, the remote UE needs to store the configuration associated with the relay link path upon transition to the RRC inactive state.

In operation (d), the remote UE resumes the connection, e.g., a UL data arrival or reception of a radio access network (RAN) paging message. In some embodiments, if the UE configured with multi-paths receives the release message including suspend configuration, the remote UE needs to store the configuration associated with the relay link path upon transition to the RRC inactive state. When the remote UE resume the connection, the remote UE may release the configuration associated with the relay link path.

In operation (e), the remote UE enters the RRC connected state.

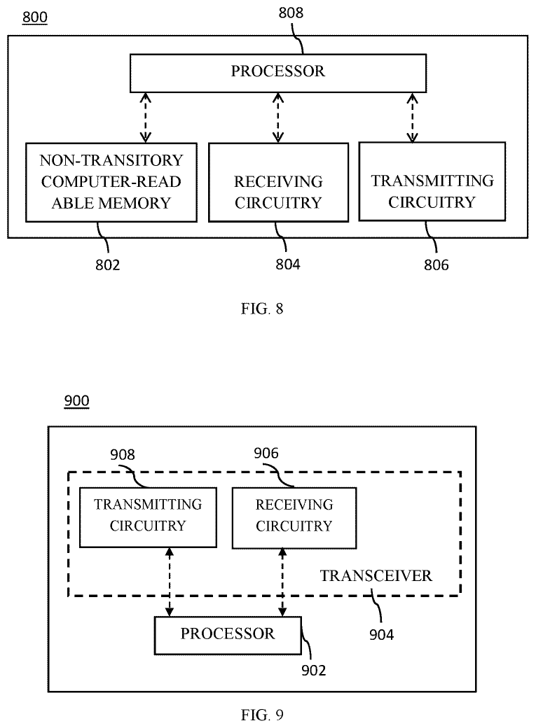

FIG. 8 illustrates an exemplary block diagram of an apparatus for a multi-path case in accordance with some embodiments of the subject application. As shown in FIG. 8, the apparatus 800 may include at least one non-transitory computer-readable medium 802, at least one receiving circuitry 804, at least one transmitting circuitry 806, and at least one processor 808 coupled to the non-transitory computer-readable medium 802, the receiving circuitry 804 and the transmitting circuitry 806. The at least one processor 808 may be a CPU, a DSP, a microprocessor etc. The apparatus 800 may be a remote UE, a relay UE, or a network node (e.g., a BS) configured to perform a method illustrated in the above or the like.

Although in this figure, elements such as the at least one processor 808, receiving circuitry 804, and transmitting circuitry 806 are described in the singular, the plural is contemplated unless a limitation to the singular is explicitly stated. In some embodiments of the subject application, the receiving circuitry 804 and the transmitting circuitry 806 can be combined into a single device, such as a transceiver. In certain embodiments of the subject application, the apparatus 800 may further include an input device, a memory, and/or other components.

In some embodiments of the subject application, the non-transitory computer-readable medium 802 may have stored thereon computer-executable instructions to cause a processor to implement the methods with respect to a remote UE, a relay UE, or a network node (e.g., a BS) as described or illustrated above. For example, the computer-executable instructions, when executed, cause the processor 808 interacting with receiving circuitry 804 and transmitting circuitry 806, so as to perform the steps with respect to a remote UE, a relay UE, or a network node (e.g., a BS) as described or illustrated above.

FIG. 9 illustrates a further exemplary block diagram of an apparatus for a multi-path case in accordance with some embodiments of the subject application. Referring to FIG. 9, the apparatus 900, for example a BS or a UE, may include at least one processor 902 and at least one transceiver 904 coupled to the at least one processor 902. The transceiver 904 may include at least one separate receiving circuitry 906 and transmitting circuitry 908, or at least one integrated receiving circuitry 906 and transmitting circuitry 908. The at least one processor 902 may be a CPU, a DSP, a microprocessor etc.

According to some other embodiments of the subject application, when the apparatus 900 is a UE, the processor 902 may be configured to: receive an RRC reconfiguration message for path addition via the transceiver 904 from a network, wherein the RRC reconfiguration message for path addition includes an identifier (ID) of a relay UE; start a timer for a path addition procedure upon reception of the RRC reconfiguration message; and receive a message associated with a link between the relay UE and the network.

According to some embodiments of the subject application, when the apparatus 900 is a UE, the processor 902 may be configured to: access a serving cell of a network via multiple paths, wherein the multiple paths include at least one of a direct path and an indirect path via a source relay UE; receive, via the transceiver 904 from the serving cell, one of: a radio resource control (RRC) reconfiguration message for a path switch procedure from the indirect path to another indirect path via a target relay UE, a release message without a suspend configuration, and a release message including the suspend configuration; and release the indirect path upon reception of the release message without the suspend configuration.

According to some embodiments of the subject application, when the apparatus 900 is a relay UE, the processor 902 may be configured to transmit a message associated with a link between the relay UE and a network via the transceiver 904 to a remote UE, wherein the message is one of: a notification message; a PC5 unicast link release message; and a rejection message due to occurrence of a cell change or a base station (BS) change.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”. Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the subject application, but is not used to limit the substance of the subject application.

1. A user equipment (UE), comprising:
at least one memory; and
at least one processor coupled with the at least one memory and configured to cause the UE to:
receive a first radio resource control (RRC) reconfiguration message for path addition from a network, wherein the first RRC reconfiguration message for path addition includes an identifier (ID) of a relay UE;
start a timer for a path addition procedure upon reception of the first RRC reconfiguration message; and
receive a first message associated with a link between the relay UE and the network.

2. The UE of claim 1, wherein the first message is one of:
a notification message received by the UE from the relay UE; and
a PC5 unicast link release message.

3. The UE of claim 2, wherein the notification message indicates at least one of:
a Uu radio link failure (RLF) between the relay UE and the network;
a cell reselection of the relay UE;
a handover of the relay UE;
an RRC connection failure of the relay UE;
an RRC connection rejection message received by the relay UE;
an expiry of a timer for RRC setup request at the relay UE; or
an RRC resume failure of the relay UE.

4. The UE of claim 1, wherein the at least one processor is configured to cause the UE to stop the timer for the path addition procedure upon reception of the first message.

5. The UE of claim 1, wherein the at least one processor is configured to cause the UE to:
determine whether a cell change or a base station (BS) change of the relay UE occurs,
release a PC5 link between the relay UE and the UE in response to determining that the cell change or the BS change of the relay UE occurs; or
continue to establish and keep the PC5 link in response to determining that the cell change or the BS change of the relay UE does not occur.

6. The UE of claim 4, wherein the at least one processor is configured to cause the UE to transmit an indication for indicating that a PC5 link between the relay UE and the UE has been released or not to the network.

7. The UE of claim 1, wherein the at least one processor is configured to cause the UE to:
initiate a failure information procedure upon reception of the first message; and
transmit a failure message including a failure cause to the network, wherein the failure cause is one of:
reception of a notification message due to a Uu radio link failure (RLF) between the relay UE and the network;
reception of a notification message due to a cell reselection of the relay UE;
reception of a notification message due to a handover of the relay UE;
reception of a notification message due to an RRC connection failure of the relay UE;
reception of a notification message due to an RRC connection rejection message received by the relay UE;
reception of a notification message due to an expiry of a timer for RRC setup request at the relay UE;
reception of a notification message due to an RRC resume failure of the relay UE; or
reception of a PC5 unicast link release message indicated by an upper layer of the UE.

8. The UE of claim 1, wherein the at least one processor is configured to cause the UE to:
store configuration information including the ID of the relay UE in response to the UE keeping a PC5 link between the relay UE and the UE after receiving the first message;
receive a second RRC reconfiguration message including the ID of the relay UE for the path addition procedure; and
re-add the path between the relay UE and the network using the stored configuration information.

9. The UE of claim 1, wherein the at least one processor is configured to cause the UE to transmit information regarding an intra-cell path addition or an intra-base station (BS) path addition to the relay UE.

10. The UE of claim 9, wherein the at least one processor is configured to cause the UE to receive a PC5 unicast link release message or a rejection message due to occurrence of a cell change or a BS change of the relay UE from the relay UE.

11-15. (canceled)

16. A relay user equipment (UE), comprising:
at least one memory; and
at least one processor coupled with the at least one memory and configured to cause the UE to:
transmit, to a remote UE, a first message associated with a link between the relay UE and a network, wherein the first message is one of:
a notification message;
a PC5 unicast link release message; or
a rejection message due to occurrence of a cell change or a base station (BS) change.

17. The relay UE of claim 16, wherein the relay UE is a target relay UE during a path addition procedure.

18. The relay UE of claim 17, wherein the notification message indicates at least one of:
a Uu radio link failure (RLF) between the target relay UE and the network;
a cell reselection of the target relay UE;
a handover of the target relay UE;
a radio resource control (RRC) connection failure of the target relay UE;
an RRC connection rejection message received by the target relay UE;
an expiry of a timer for RRC setup request at the target relay UE; or
an RRC resume failure of the target relay UE.

19. The relay UE of claim 17, wherein the at least one processor is configured to cause the relay UE to receive information regarding an intra-cell path addition or an intra-BS path addition from the remote UE.

20. The relay UE of claim 17, wherein during the path addition procedure, the at least one processor is configured to cause the relay UE to:
not change from a first cell to a second cell or not change from a first BS to a second BS during a cell selection or reselection operation, in response to the relay UE being in an RRC idle state or an inactive state; or
not enter into an RRC connected state, in response to the relay UE changing to the second cell or the second BS.

21. The relay UE of claim 20, wherein the at least one processor is configured to cause the relay UE to transmit the PC5 unicast link release message or the rejection message in response to the relay UE changing to the second cell or the second BS.

22. The relay UE of claim 16, wherein the relay UE is a source relay UE during a path switch procedure from a first indirect path to a second indirect path, wherein the first indirect path is between the remote UE and the network via the source relay UE, and wherein the second indirect path is between the remote UE and the network via a second target relay UE.

23. The relay UE of claim 22, wherein the notification message indicates at least one of:
a Uu radio link failure (RLF) between the source relay UE and the network;
a cell reselection of the source relay UE;
a handover of the source relay UE;
a radio resource control (RRC) connection failure of the source relay UE;
an RRC connection rejection message received by the source relay UE;
an expiry of a timer for RRC setup request at the source relay UE; or
an RRC resume failure of the source relay UE.

24. A processor for wireless communication, comprising:
at least one controller coupled with at least one memory and configured to cause the processor to:
receive a first radio resource control (RRC) reconfiguration message for path addition from a network, wherein the first RRC reconfiguration message for path addition includes an identifier (ID) of a relay UE;
start a timer for a path addition procedure upon reception of the first RRC reconfiguration message; and
receive a first message associated with a link between the relay UE and the network.

25. A method performed by a user equipment (UE), the method comprising:
receiving a first radio resource control (RRC) reconfiguration message for path addition from a network, wherein the first RRC reconfiguration message for path addition includes an identifier (ID) of a relay UE;
starting a timer for a path addition procedure upon reception of the first RRC reconfiguration message; and
receiving a first message associated with a link between the relay UE and the network.
